(19) United States
(12) Patent Application Publication
(10) Pub. No.: US 2018/0288643 A1
(43) Pub. Date: Oct. 4, 2018

(54) SUPPORTING FLEXIBLE BANDWIDTH OPERATION IN LTE

(71) Applicant: IPCom GmbH & Co. KG, Pullach (DE)

(72) Inventors: Andreas Schmidt, Braunschweig (DE); Achim Luft, Braunschweig (DE); Maik Bienas, Schöppenstedt (DE)

(21) Appl. No.: 15/762,915

(22) PCT Filed: Oct. 12, 2016
(86) PCT No.: PCT/EP2016/074422

§ 371 Date: Mar. 23, 2018

(30) Foreign Application Priority Data
Oct. 12, 2015 (EP) 15189366.6

(51) Int. Cl. H04W 24/10; H04W 8/24

(52) U.S. Cl. CPC H04W 24/10; H04W 72/0453; H04W 8/24

(57) ABSTRACT

The invention provides a method for a user equipment, UE, operating in an orthogonal frequency division multiplexed, OFDM, communication system to signal that it is capable of operating at a radio bandwidth other than one predefined according to an OFDM communication standard for the system, the method comprising: the UE sending a capability information message to a base station, the message including an information field which indicates whether the UE supports flexible bandwidth operation or not, wherein the flexible bandwidth operation is at least one of an increase and a decrease in a number of subcarriers to be used by the UE within a frequency band being used concurrently for communication with the base station by other UEs over the bandwidth defined according to the OFDM communication standard.

The present invention relates to the provision of flexible bandwidth in an OFDM communication system such as a Long Term Evolution, LTE, radio communication system.

As currently defined in the standards agreed by 3GPP, in LTE the nominal bandwidth sizes that are supported since 3GPP LTE release 8 are restricted to six possible bandwidths, comprising 6, 15, 25, 50, 75 or 100 resource blocks. The number of usable subcarriers is defined by twelve times the number of resource blocks, as there are twelve sub carriers per resource block. The usable bandwidth is defined by the number of sub carriers and the sub carrier spacing (15 kHz in most cases). The edges of the LTE channel bandwidth are guard bands. Thus, only approximately 90% of the nominal channel bandwidth can actually be used. The LTE bandwidth definitions of table 1 are static, i.e. any bandwidth sizes other than the ones listed in table 1 are currently ruled out.

TABLE 1

| | | | Usable |
|---|---|---|---|
| | | Usable | Bandwidth |
| | | Bandwidth | in number |
| Channel | Usable | in number of | of resource |
| Bandwidth | Bandwidth | subcarriers | blocks |
| 1.4 MHz | 1.08 MHz | 72 | 6 |
| 3 MHz | 2.7 MHz | 180 | 15 |
| 5 MHz | 4.5 MHz | 300 | 25 |
| 10 MHz | 9 MHz | 600 | 50 |
| 15 MHz | 13.5 MHz | 900 | 75 |
| 20 MHz | 18 MHz | 1200 | 100 |

In LTE standard TS 36.211, a downlink resource grid is illustrated in FIG. 6.2.2-1 showing a resource block comprised of resource elements having a width of N_{symb}^{DL} OFDM symbols and a height of N_{sc}^{RB} subcarriers. In this example configuration normal cyclic prefix (seven OFDM symbols per slot) and a sub carrier spacing of 15 kHz is used (cf. Table 2).

TABLE 2

| | | |
|---|---|---|
| Configuration | N_{sc}^{RB} | N_{symb}^{DL} |

| | | | |
|---|---|---|---|
| Normal cyclic prefix | Δf = 15 kHz | 12 | 7 |
| Extended cyclic prefix | Δf = 15 kHz | | 6 |
| | Δf = 7.5 kHz | 24 | 3 |

which corresponds to Table 6.2.3-1 of 3GPP TS 36.211.

Some portions of the spectrum defined for IMT-advanced are currently under-utilized because in certain countries the channelization plan results in spectrum blocks allocated to a Mobile Network Operator (MNO) that do not exactly correspond to the specified nominal LTE bandwidth sizes supported since 3GPP Rel-8 described above.

Such cases may for instance arise when spectrum is displaced or re-used from GSM or UMTS to LTE within one operator's licensed spectrum.

Spectrum allocations across the world show a large variety of non-standard spectrum block sizes (e.g. 1.8, 2.0, 2.2, 4.4, 4.6, 6, 6.2, 7.8, 7.0, 8.0, 11, 14, 18, 19 MHz), which makes it difficult for 3GPP to address this problem by defining new standardized nominal LTE bandwidth sizes. Furthermore, the alternative to utilize carrier aggregation (a new feature in LTE introduced in 3GPP Rel-10) within a non-standard block size would still not fully utilize the available spectrum (except in special cases), and it would require the addition of many new band combinations in the LTE specifications. A further drawback with carrier aggregation is the fact that only 90% of the channel bandwidth may effectively be used for data transmissions due to the presence of guard bands that are an inherent part of each carrier's spectrum at both edges of the respective frequency range.

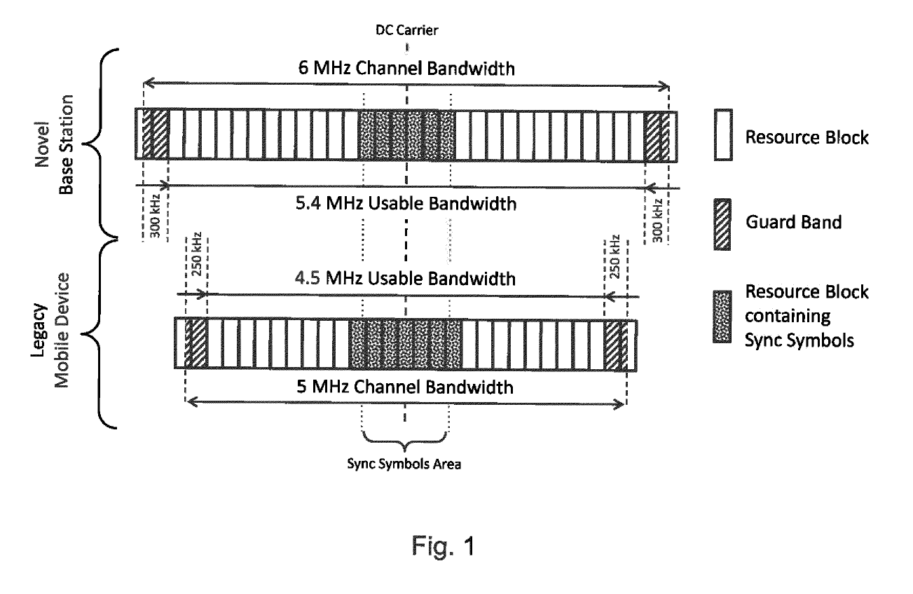

Therefore, in order to increase the spectrum utilization in these non-standard spectrum blocks, there is a need to define a generic radio framework that maximizes the spectrum utilization under a known but arbitrary spectrum block size larger than 1.4 MHz and smaller than 20 MHz. An example of such a non-standard spectrum block (here: a frequency range of 6 MHz Channel Bandwidth for the downlink) is depicted in FIG. 1.

This topic has been raised by Huawei in 3GPP RAN meetings, for example RAN meetings #67 and #68 with submitted documentation including documents RP-150237 and RP-150513.

Huawei's proposal is that the entire licensed spectrum size of a non-standard spectrum block (such as the example frequency block of 6 MHz channel bandwidth depicted in FIG. 1) can be used by the mobile network operator with the possibility to schedule for different user equipment, UE, different parts of this spectrum block, and to continue supporting legacy UEs at least in some part of the spectrum block as well. Utilization of non-standard spectrum blocks would require an LTE carrier to be extendable or compressible in the granularity of e.g. one to a few resource blocks (or even at sub carrier level), in order to take advantage of the hundreds of kHz (up to a few MHz) of resources not being utilized in a non-standard spectrum block.

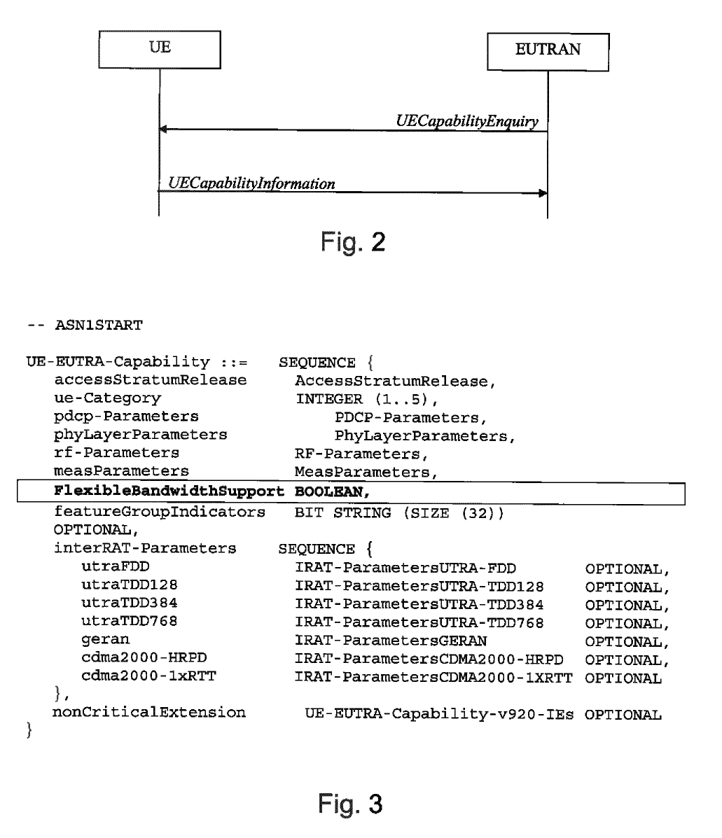

3GPP TS 36.306 lists various capability parameters for functions for which there is a possibility for UEs to signal different values. 3GPP TS 36.331 defines the encoding of the above mentioned Information Elements (IE) and describes the messages to be exchanged in context of the UE Capability Transfer procedure (cf. FIG. 2). The network may initiate the procedure to a UE in RRC_CONNECTED when it needs (initial or additional) a particular UE's capability information. The base station (eNodeB) is required to respect the signalled capability parameters when configuring the UE and when scheduling the UE.

Any UE's radio access capabilities may contain several sets of Radio Access Technology (RAT) capabilities, such as capabilities for E-UTRA, UTRA, GERAN-CS, GERAN-PS, CDMA2000, so the entire set of information can become very large. In order to reduce the load on the air interface during transition from RRC_IDLE mode to RRC_CONNECTED mode, the Mobility Management Entity (MME) may store the UE's capabilities and provide them to the base station (eNodeB) during initial UE context setup over the S1 interface. In case the MME doesn't have a valid set of UE capabilities, the base station (eNodeB) may choose to acquire the capabilities from the mobile device directly using the UE CAPABILITY ENQUIRY message of FIG. 2. This message may contain a list of those RATs for which the UE is requested to transfer its radio access capabilities. In response to it, the UE CAPABILITY INFORMATION message is used to transfer the requested radio access capabilities of the UE to the base station (eNodeB).

US 2013/0148627 A1 describes a flexible bandwidth carrier system in which the flexible bandwidth is provided in an extension to UTRAN, called “flexible UTRAN” or F-UTRAN and accordingly is described in connection with the UMTS radio access technology. The UTRAN may issue a capability enquiry message to a UE which responds with an indication as to whether the UE supports flexible bandwidth UMTS carriers and in which frequency bands. In such a UMTS system, the system bandwidth considered from a power spectral density/frequency viewpoint is symmetrical about a central frequency.

The present invention provides a mechanism for a UE to indicate to the network that it is able to support flexible bandwidth configurations in OFDM systems such as LTE which is not possible with known arrangements.

Accordingly, the present invention provides a method for a user equipment, UE, operating in an orthogonal frequency division multiplexed, OFDM, communication system to signal that it is capable of operating at a radio bandwidth other than one predefined according to an OFDM communication standard for the system according to claim 1. Further preferred aspects of the method of the invention are provided according to the dependent claims.

LTE is an example of a system which uses orthogonal frequency division multiplexing (OFDM) in a downlink direction. For this invention, the term “flexible bandwidth” operation relates to a method to expand or compress a spectrum block size by activating or deactivating a certain number of OFDM sub carriers. This may even be done in an asymmetrical fashion (for example, only at one end of the frequency range). Control parameters to be used for these operations are for instance the number of sub carriers or the number of resource blocks or a frequency range expressed in Hz (to be added to or deleted from a standardized bandwidth allowing for different granularity). In the invention, the sub carrier spacing is not changed. Doing so a cell may offer both a standardized system bandwidth (that legacy UEs can benefit from) and a non-standardized system bandwidth (that new mobile terminals may utilize) at the same time. Legacy UEs require the DC-carrier (as well as the cell's sync symbols) to appear in the center of the frequency range. By means of the invention, mobile terminals may indicate to the base station their capability to operate with a shift of the DC carrier (and the cell's sync symbols).

In a further aspect, the invention provides a user equipment device capable of operating at a flexible bandwidth and for signalling its capabilities in this regard. The invention also provides base station equipment arranged to store information provided by user equipment devices as to their capability of operating with flexible bandwidth.

A UE is enabled to indicate to the infrastructure side (eNodeB and/or MME) its individual capabilities pertaining to the spectrum flexibility concept described above.

A base station is enabled to configure mobile devices (namely, those supporting the new spectrum flexibility concept) with a higher degree of bandwidth efficiency. Also, handover of a mobile device into another cell can be based on the UE's individual bandwidth flexibility capabilities, thereby improving the handover efficiency as well.

The MME may store and provide the information (if required) to the respective base station (eNodeB) over the S1 interface for example in case of RRC state transitions. Therefore costly signalling over the LTE air interface is avoided.

The invention provides assistance for the realization of the concept of bandwidth flexibility in LTE that enables Mobile Network Operator (MNO) allocated spectrum blocks which do not exactly correspond to the specified nominal bandwidth sizes defined for 3GPP LTE to use their spectrum blocks more efficiently. Spectrum re-farming from GSM or UMTS to LTE within one operators licensed spectrum becomes much easier.

Preferred embodiments of the invention will now be described, by way of example only, with reference to the accompanying drawings in which:

FIG. 1 is a schematic illustration of LTE operation using a flexible bandwidth;

FIG. 2 is a schematic representation of information exchange between EUTRAN and UE;

FIG. 3 is an example of an information element of a first embodiment of the invention;

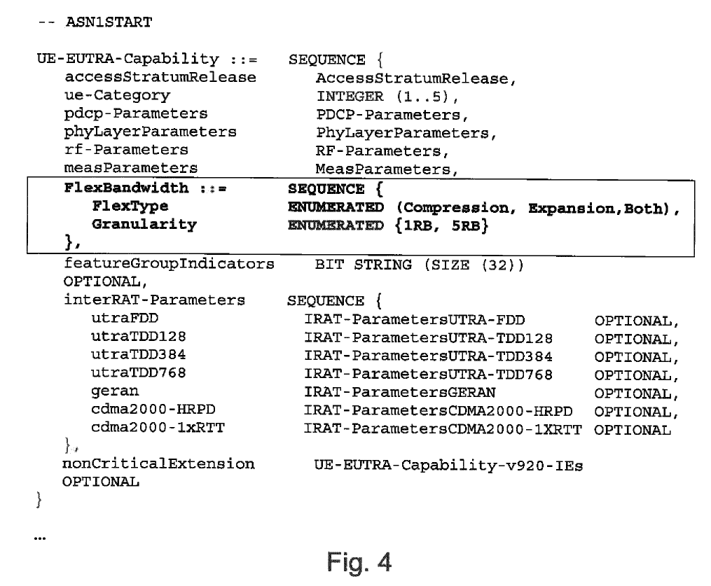

FIG. 4 is an example of an information element of a second embodiment of the invention; and

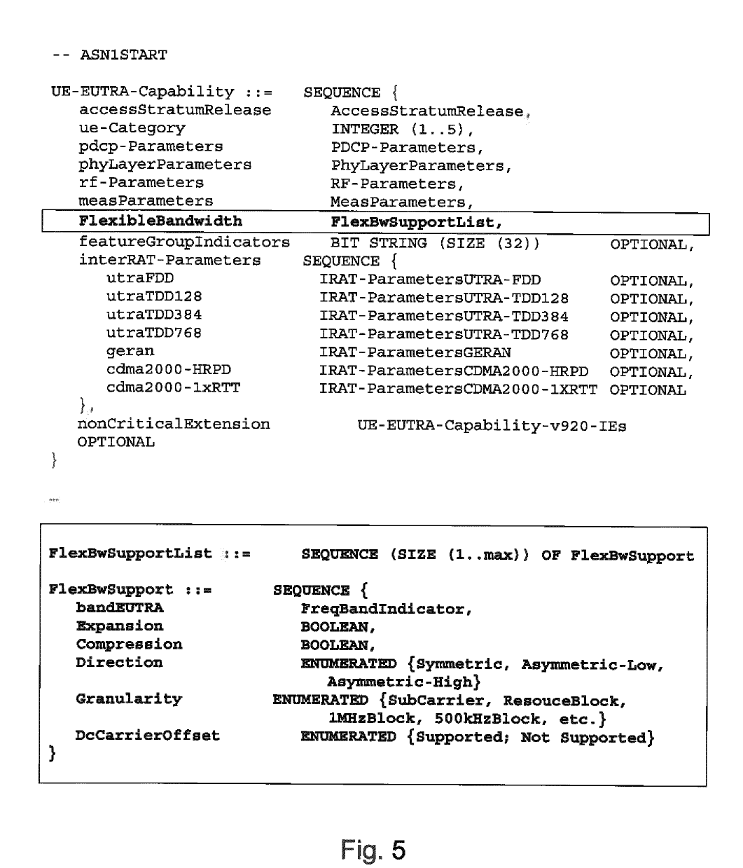

FIG. 5 is an example of an information element of a third embodiment of the invention.

### DETAILED DESCRIPTION OF THE PREFERRED EMBODIMENTS

In the following new fields for inclusion into the UE's list of capabilities are described. In the scope of the present invention the so-called UE-SUTRA-Capability information element, IE, as described in section 6.3.6 of 3GPP TS 36.331 is of relevance. This IE is used to convey the E-UTRA UE Radio Access Capability Parameters (see TS 36.306), and the Feature Group Indicators for mandatory features (see Annexes B.1 and C.1 in TS 36.331) to the network. The UE-EUTRA-Capability IE may be transferred in E-UTRA or in another RAT.

The names and encoding variants of the novel fields and parameters discussed here shall be understood to serve merely as examples. There are many other options to get the information from the mobile device across the air to the base station. This invention is by no means restricted to the encoding examples disclosed.

Furthermore, the newly proposed parameters to be used by a UE to signal its “Bandwidth Flexibility” capabilities may be arranged in more than one way, for example they may be collated in a new or already existing hierarchical structure, or grouped together with other fields for instance in a list of “mandatory features”, “optional features”, “conditionally mandatory features”, or be assigned to a particular “feature group”. In the latter case only a Feature Group Indicator (FGI) would have to be signalled (as part of the UE-EUTRA-Capability IE) from the UE to the infrastructure side instead of a list of distinct parameters.

In the following, the new fields to be included in the UE-EUTRA-Capability IE are highlighted in bold letters and encircled with a box.

### Embodiment 1

This embodiment reproduced in FIG. 3 represents the simplest embodiment of the present invention. The UE is enabled to signal general support for the “Bandwidth Flexibility” concept. The new field is labelled “FlexibleBandwidthSupport” and is a simple flag of category “Boolean” used to indicate whether a UE supports the “Flexible Bandwidth” concept or not.

### Embodiment 2

This embodiment is reproduced in FIG. 4. In this example, a new field is specified “FlexBandwidth” which is used to specify a UE's flexible bandwidth characteristics. The field contains two new sub-fields, “FlexType” and “Granularity”. FlexType is a parameter used to indicate whether the UE is able to either expand or compress E-UTRA frequency bands, or both while granularity is a parameter used to inform the infrastructure side about the granularity supported by the UE. In FIG. 4, two different step sizes are defined: the value 1 RB indicates a step size of one resource block (which corresponds to 180 kHz); the value 5 RB indicates a step size of five resource blocks (which corresponds to 900 kHz). In the LTE resource lattice there are always 180 kHz per Resource Block regardless of the sub carrier spacing configuration, because 12 sub carriers are used in case of 15 kHz spacing and 24 sub carriers are used in case of 7.5 kHz spacing.

### Embodiment 3

This embodiment is reproduced in FIG. 5 and is the most complex of the three. It offers maximum adaptability for the signalling of capabilities pertaining to the bandwidth flexibility concept. It allows for different flexibility per E-UTRA frequency band.

The embodiment provides the field “FlexBwSupportList” with up to “max” entries (one for each E-UTRA frequency band) used to specify a UE's flexible bandwidth capabilities. A further field “FlexBwSupport” comprises a set of flexible bandwidth parameters per E-UTRA frequency band. The field “bandEUTRA” may be used to specify the E-UTRA frequency band in question. The field “Expansion” is a parameter used to indicate whether the UE is able to expand the respective E-UTRA frequency band in order to form non-standard spectrum block sizes while the field “Compression” is a parameter used to indicate whether the UE is able to shrink the respective E-UTRA frequency band in order to form non-standard block sizes. Field “Direction” is a parameter used to indicate whether the UE is able to expand or compress the respective E-UTRA frequency band symmetrically or asymmetrically (and in the latter case at what end).

The field “Granularity” as previously is a parameter used to inform the infrastructure side about the granularity supported by the UE (step size) when an E-UTRA frequency band is expanded or compressed. The value SubCarrier indicates sub carrier level (i.e. the step size is 15 kHz (or 7 kHz depending on the configuration of sub carrier spacing)); the value ResourceBlock indicates resource block level (i.e. the step size is one Resource Block which corresponds to 180 kHz); the value 1 MHzBlock indicates units of 1 MHz; the value of 500 kHzBlock indicates units of 500 kHz; and so on.

The field “DcCarrierOffset” is a parameter used to indicate whether the UE is able to shift the DC Carrier of the respective E-UTRA frequency band (for example, to move the resource block alignment of the entire frequency band in question about half the bandwidth of one resource block (i.e. 6 or 12 sub carriers, depending on the configuration of sub carrier spacing, up or down). This may be necessary when the initial standardized frequency band comprises an even (odd) number of resource blocks and the target non-standardized frequency band comprises an odd (even) number of resource blocks.

1. A method for a user equipment, UE, operating in an orthogonal frequency division multiplexed, OFDM, communication system to signal that it is capable of operating at a radio bandwidth other than one predefined according to an OFDM communication standard for the system, the method comprising:
the UE sending a capability information message to a base station, the message including an information field which indicates whether the UE supports flexible bandwidth operation or not, wherein the flexible bandwidth operation is at least one of an increase and a decrease in a number of subcarriers to be used by the UE within a frequency band being used concurrently for communication with the base station by other UEs over a radio bandwidth pre-defined according to the OFDM communication standard.

2. The method according to claim 1, wherein the message includes an information field which indicates whether the UE is able to support at least one of bandwidth compression and bandwidth expansion.

3. The method according to claim 2, wherein the message includes an information field indicating a step size by which the UE is capable of changing the bandwidth.

4. The method according to claim 1, wherein the message includes an information field which indicates whether the UE is capable of changing the bandwidth in a symmetric or asymmetric manner.

5. The method according to claim 4, wherein the message includes an information field which indicates whether the UE is able to shift a DC carrier of a respective frequency band.

6. The method according to claim 1, wherein the message includes a set of flexible bandwidth parameters for each frequency band for which the UE is capable of operating with flexible bandwidth.

7. The method according to claim 1, wherein the OFDM communication standard is a long term evolution, LTE, communication standard.

8. The method according to claim 1, wherein the flexible bandwidth operation is at least one of an increase and a decrease in a number of resource blocks.

9. The method according to claim 1, wherein the capability information message is sent in response to a request from the base station.

10. A user equipment, UE, adapted to transmit an information message to a base station, the information message indicating a capability of the UE to operate in a flexible bandwidth mode when operating in an orthogonal frequency division multiplexed, OFDM, communication system at a bandwidth other than a radio bandwidth pre-defined according to an OFDM communication standard, wherein the flexible bandwidth mode is an operating mode implementing at least one of an increase and a decrease in a number of subcarriers to be used by the UE within a frequency band being used concurrently for communication with the base station by other UEs over the radio bandwidth pre-defined according to the OFDM communication standard.

11. Base station equipment capable of operating according to an orthogonal frequency division multiplexed, OFDM, communication standard, wherein the base station is capable of operating at a frequency band having a radio bandwidth other than a radio bandwidth pre-defined according to the OFDM communication standard and wherein the base station equipment is adapted to store information relating to a capability of connected user equipment, UE, devices to operate with a flexible bandwidth, wherein the flexible bandwidth operation is at least one of an increase and a decrease in a number of subcarriers to be used by the UEs within a frequency band being used concurrently for communication with the base station by other UEs over the radio bandwidth pre-defined according to the OFDM communication standard.

12. A mobile communication system operating according to an orthogonal frequency division multiplexed, OFDM, communication standard, wherein a connected user equipment, UE, device's capabilities pertaining to operation at a radio bandwidth other than one predefined according to the OFDM communication standard are at least partially taken into account for handover decisions.
